(19) United States
(12) Patent Application Publication
(10) Pub. No.: US 2024/0341356 A1
(43) Pub. Date: Oct. 17, 2024

(54) AEROSOL GENERATION DEVICE AND AEROSOL GENERATION SYSTEM

(71) Applicant: Japan Tobacco Inc., Tokyo (JP)

(72) Inventors: Reijiro KAWASAKI, Tokyo (JP); Takahiro SAKAMOTO, Tokyo (JP)

(73) Assignee: Japan Tobacco Inc., Tokyo (JP)

(21) Appl. No.: 18/752,822

(22) Filed: Jun. 25, 2024

Related U.S. Application Data
(63) Continuation of application No. PCT/JP2021/048924, filed on Dec. 28, 2021.

(51) Int. Cl. A24F 40/40

(52) U.S. Cl. CPC A24F 40/40

(57) ABSTRACT

An aerosol generation device includes: an accommodating portion provided in a case and configured to accommodate at least a part of an aerosol source; a microwave oscillation unit configured to oscillate microwaves; a power source unit configured to supply electric power to the microwave oscillation unit; an antenna configured to supply the microwaves to the accommodating portion; an isolator connected between the microwave oscillation unit and the accommodating portion; and an air flow path configured to allow air to be taken into the accommodating portion from an outside of the case, in which the isolator includes a circulator that separates incident waves oscillated from the microwave oscillation unit and reflected waves reflected from the accommodating portion.

### CROSS-REFERENCE TO RELATED APPLICATION

This application is a continuation of International Patent Application No. PCT/JP2021/048924 filed on Dec. 28, 2021, the content of which is incorporated herein by reference.

### TECHNICAL FIELD

The present invention relates to an aerosol generation device and an aerosol generation system.

### BACKGROUND ART

An aerosol generation device such as a heating-type tobacco is equipped with a heating unit that heats an aerosol forming article (capsule, stick, or the like) in which an aerosol source is incorporated. WO2021/013477A discloses an aerosol generation device in which a high-frequency oscillator that oscillates microwaves (electromagnetic waves having a frequency between 300 MHz and 300 GHz) is used as a heating unit, and discloses a configuration in which an aerosol source is heated with the microwaves. The heating method using microwaves is advantageous in that the aerosol source can be uniformly heated, and deposition of a residue of the aerosol source on the heating unit can be prevented because of non-contact heating.

In the heating method using the microwaves, among the microwaves emitted from an emission unit, reflected waves that are reflected without being absorbed by the aerosol forming article and return to the high-frequency oscillator may make an operation of the high-frequency oscillator unstable and lead to a failure of the high-frequency oscillator.

An object of the present invention is to provide an aerosol generation device and an aerosol generation system in which a high-frequency oscillation unit can be prevented from reflected waves.

### SUMMARY OF INVENTION

According to an aspect of the present invention, there is provided an aerosol generation device that includes:

an accommodating portion provided in a case and configured to accommodate at least a part of an aerosol source;

a microwave oscillation unit configured to oscillate microwaves;

a power source unit configured to supply electric power to the microwave oscillation unit;

an antenna configured to supply the microwaves to the accommodating portion;

an isolator connected between the microwave oscillation unit and the accommodating portion; and

an air flow path configured to allow air to be taken into the accommodating portion from an outside of the case, and the isolator includes a circulator that separates incident waves oscillated from the microwave oscillation unit and reflected waves reflected from the accommodating portion.

According to another aspect of the present invention, there is provided an aerosol generation system that includes:
an aerosol forming article containing an aerosol source;
an accommodating portion provided in a case and configured to accommodate at least a part of the aerosol source;
a microwave oscillation unit configured to oscillate microwaves;
a power source unit configured to supply electric power to the microwave oscillation unit;
an antenna configured to supply the microwaves to the accommodating portion;
an isolator connected between the microwave oscillation unit and the accommodating portion; and
an air flow path configured to allow air to be taken into the accommodating portion from an outside of the case, and the isolator includes a circulator that separates incident waves oscillated from the microwave oscillation unit and reflected waves reflected from the accommodating portion.

### BRIEF DESCRIPTION OF DRAWINGS

FIG. 1 is a schematic diagram of an aerosol generation system 1 according to a first embodiment of the present invention.

FIG. 2 is a schematic diagram of an aerosol generation system 1 according to a second embodiment of the present invention.

FIG. 3 is a perspective view showing a configuration of a tobacco stick 100.

FIG. 4 is a cross-sectional view showing the configuration of the tobacco stick 100.

### DESCRIPTION OF EMBODIMENTS

Hereinafter, an aerosol generation system according to each embodiment of the present invention will be described with reference to the drawings.

### First Embodiment

### (Overview of Aerosol Generation System 1)

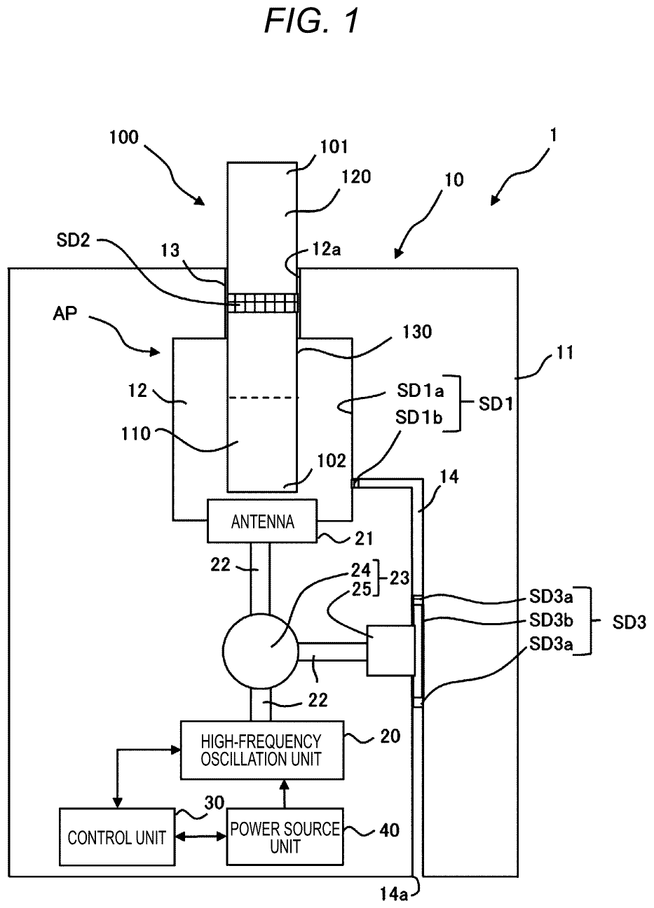

An aerosol generation system 1 according to a first embodiment of the present invention will be described with reference to FIG. 1. The aerosol generation system 1 does not need to include all of the following configurations, and may not include a part of components.

The aerosol generation system 1 includes a tobacco stick 100 in which a flavor source and an aerosol source are incorporated, and a flavor inhaler 10 for generating an aerosol by heating the aerosol source with microwaves and inhaling the generated aerosol. The aerosol generation system 1 preferably has a size that fits in hands. Here, the flavor inhaler 10 corresponds to an “aerosol generation device” in the present invention.

The tobacco stick 100 according to the present embodiment has a substantially cylindrical rod shape. The tobacco stick 100 includes a tobacco rod portion 110, a mouthpiece portion (inhalation port portion) 120, and a tipping paper 130 integrally coupling these portions. The tipping paper 130 is wrapped around the mouthpiece portion 120 and the tobacco rod portion 110, and thus the mouthpiece portion 120 is coaxially coupled to the tobacco rod portion 110. Although not particularly illustrated, the tobacco stick 100 may include, at an end thereof upstream the tobacco rod portion 110, a plug portion implemented by a filter segment or the like that prevents falling off of a tobacco filling material. Here, the tobacco stick 100 corresponds to an “aerosol forming article” in the present invention.

Reference numeral 101 denotes a mouthpiece end of the tobacco stick 100 (mouthpiece portion 120). Reference numeral 102 denotes a tip end opposite to the mouthpiece end 101 of the tobacco stick 100. The tobacco rod portion 110 is disposed on a tip end 102 side of the tobacco stick 100.

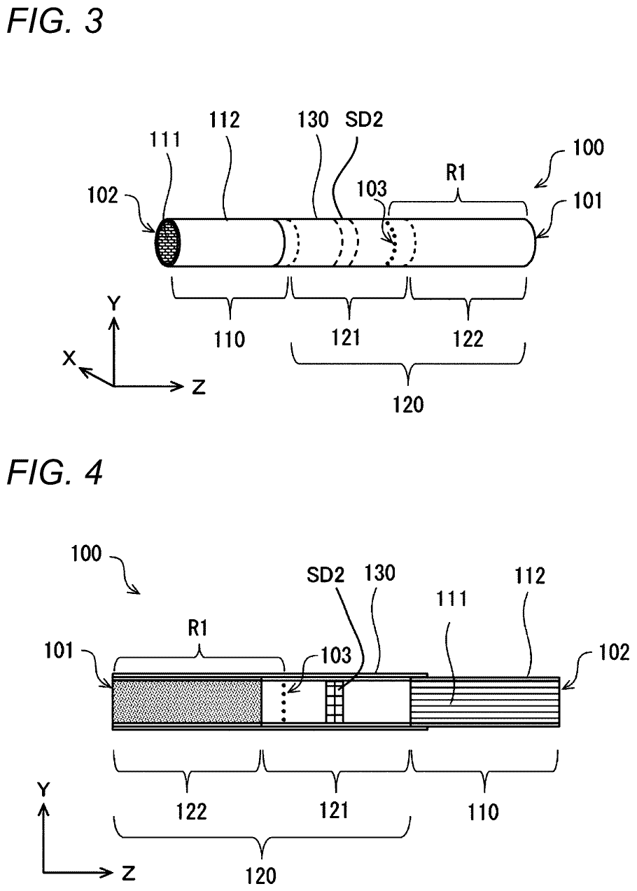

The mouthpiece portion 120 is provided with a microwave shield SD2 that blocks microwaves and allows air to pass therethrough. The tobacco stick 100 is attachable to and detachable from the flavor inhaler 10 such that the microwave shield SD2 and the tobacco rod portion 110 are disposed inside the flavor inhaler 10. Details of the tobacco stick 100 will be described later with reference to FIGS. 3 and 4.

The flavor inhaler 10 includes a case 11 on which various components to be described later are mounted. The case 11 is provided with an accommodating portion 12 capable of accommodating at least a part of the tobacco stick 100 from an opening portion 12a; a guide portion 13 disposed between the opening portion 12a and the accommodating portion 12 and used for guiding insertion of the tobacco stick 100; and an air flow path 14 that is in communication with the accommodating portion 12 and can introduce air into the accommodating portion 12. The guide portion 13 is a hole having substantially the same size as an outer diameter of the tobacco stick 100, and is in communication with the accommodating portion 12. The air flow path 14 includes an air intake port 14a that is opened to the outside. The air flow path 14 is provided at any position, and may be provided on a bottom surface of the accommodating portion 12 or may be provided along the guide portion 13.

The flavor inhaler 10 further includes a high-frequency oscillation unit 20, an antenna 21, an isolator 23, a control unit 30, and a power source unit 40.

The high-frequency oscillation unit 20 is, for example, a solid state oscillator, and generates a high-frequency electromagnetic field of a predetermined frequency. The solid state oscillator is, for example, an LDMOS transistor, a GaAs FET, a SiC MESFET, or a GaN HFET. In the present description, the high-frequency electromagnetic field means a high-frequency electromagnetic field having a frequency between 3 Hz and 3 THz. The microwave means a high-frequency electromagnetic field having a frequency between 300 MHz and 300 GHz. Although not particularly limited, the high-frequency oscillation unit 20 may generate microwaves having a frequency of 2.40 GHz to 2.50 GHz. In the present embodiment, the high-frequency oscillation unit 20 generates microwaves having a frequency of 2.45 GHz. Here, the high-frequency oscillation unit 20 corresponds to a “microwave oscillation unit” in the present invention.

The high-frequency oscillation unit 20 may include an amplifier for amplifying the high-frequency electromagnetic field. The high-frequency oscillation unit 20 may have a function of the amplifier, or the amplifier may be provided using an electronic component other than the high-frequency oscillation unit 20.

There is also a magnetron oscillator as an apparatus for generating the high-frequency electromagnetic field, but when a solid state oscillator is used as the high-frequency oscillation unit 20, a main body may be reduced in size as compared with a case of using the magnetron oscillator. The solid state oscillator can operate at a lower operating voltage as compared with the magnetron oscillator, and is high in frequency stability and output stability. However, the high-frequency oscillation unit 20 of the present embodiment may be a magnetron oscillator as long as the high-frequency electromagnetic field of the predetermined frequency can be generated.

The microwaves generated in the high-frequency oscillation unit 20 are guided to the antenna 21 through the waveguide 22. The antenna 21 radiates the microwaves for heating the aerosol source into the accommodating portion 12. A coaxial cable may be used instead of the waveguide 22. Further, when the high-frequency oscillation unit 20 and the antenna 21 are directly connected, the waveguide 22 or the coaxial cable may be omitted.

The antenna 21 has, for example, a rod shape and radiates the microwaves outward in a radial direction. A length of the antenna can be appropriately set according to a frequency of the radiated high-frequency electromagnetic waves. For example, when the antenna 21 is a rod-shaped antenna (dipole antenna) and a frequency of the generated microwaves is 2.45 GHz (a wavelength is about 120 mm), a length of the antenna can be set to about 30 mm (that is, ¼ of the wavelength). A diameter of the antenna is, for example, 1 mm. A shape of the antenna 21 is not limited to a rod shape, and for example, a planar antenna (such as a patch antenna) may be used.

The antenna 21 is disposed such that an oscillation point of the microwaves faces the accommodating portion 12. Various forms can be adopted for the arrangement of the antenna 21. At least a part of the antenna 21 may be disposed to be positioned inside the accommodating portion 12. Further, at least a part of the antenna 21 may be disposed to be inserted into or punctured into the tobacco stick 100 inside the accommodating portion 12. Further, the antenna 21 may be disposed to be in contact with the tobacco stick 100, or may be disposed to be separated from the tobacco stick 100. Further, the antenna 21 may not be positioned inside the accommodating portion 12, and a waveguide may be provided between the antenna 21 and the accommodating portion 12.

The waveguide 22 is provided with the isolator 23. The isolator 23 has a function of absorbing reflected waves that return toward the high-frequency oscillation unit 20 without being absorbed by the tobacco stick 100, and serves to protect the high-frequency oscillation unit 20 from the reflected waves. Details will be described later.

The control unit 30 functions as an arithmetic processing device and a control device, and controls overall operations in the flavor inhaler 10 according to various programs. The control unit 30 is implemented by, for example, an electronic circuit such as a central processing unit (CPU) or a microprocessor.

The power source unit 40 supplies electric power to the high-frequency oscillation unit 20 under the control of the control unit 30. The power source unit 40 is implemented by, for example, a rechargeable battery such as a lithium-ion secondary battery.

### (Microwave Shielding Structure)

In a heating method using microwaves, when the tobacco stick 100 disposed inside the accommodating portion 12 is heated, it is important that the microwaves are reliably consumed inside the accommodating portion 12. If the microwaves leak to the outside, there is a concern that an unintended influence may be exerted on the outside (a user, an electronic device in the vicinity, or the like) of the aerosol generation system 1. In the present embodiment, a microwave shielding structure is formed in the accommodating portion 12, the guide portion 13, the tobacco stick 100, and the air flow path 14.

A microwave shield SD1 is formed on inner peripheral surfaces of the accommodating portion 12 and the guide portion 13 such that the microwaves from the high-frequency oscillation unit 20 do not leak to the outside. The microwave shield SD1 includes a microwave shield SD1a formed on the inner peripheral surfaces of the accommodating portion 12 and the guide portion 13, and a microwave shield SD1b formed in the air flow path 14 in the vicinity of the accommodating portion 12.

The microwave shield SD1a is made of a material that does not transmit the microwaves, and is, for example, a metal layer made of at least one selected from the group consisting of aluminum, stainless steel, silver, gold, copper, nickel, chromium, and alloys containing these. The metal layer is formed by, for example, plating or attaching a film. Instead of the metal layer, the accommodating portion 12 and the guide portion 13 themselves may be made of metal, and in this case, the accommodating portion 12 and the guide portion 13 themselves constitute the microwave shield SD1a.

The microwave shield SD1b is provided with a plurality of holes, and the microwave shield SD1b blocks the microwaves and allows air to pass therethrough. Similar to the microwave shield SD1a, the microwave shield SD1b is made of a material that does not transmit the microwaves. The microwave shield SD1b is, for example, a metal mesh or a punched metal. Further, the microwave shield SD1b may be formed by coating a surface of a material such as a resin with a metal material. With such a configuration, a lightweight and inexpensive microwave shield SD1b can be formed. The microwave shield SD1b may be provided in the vicinity of the air intake port 14a. Here, the microwave shield SD1b corresponds to a “second microwave shield” in the present invention.

The microwave shield SD2 of the tobacco stick 100 is provided with a plurality of holes that can block the microwaves and allow air to pass therethrough. The microwave shield SD2 is, for example, a metal mesh or a punched metal. Similar to the microwave shield SD1, the microwave shield SD2 is made of a material that does not transmit the microwaves, and is made of, for example, at least one selected from the group consisting of aluminum, stainless steel, silver, gold, copper, nickel, chromium, and alloys containing these. Further, the microwave shield SD2 may be formed by coating a surface of a material such as a resin with a metal material. With such a configuration, a lightweight and inexpensive microwave shield SD2 can be formed.

When the tobacco stick 100 is reliably attached to the flavor inhaler 10, the microwave shield SD2 is disposed at a position where the guide portion 13 is formed in an insertion direction of the tobacco stick 100. Accordingly, the microwaves propagated from the accommodating portion 12 toward the microwave shield SD2 are blocked by the microwave shield SD2. The microwave shield SD2 is preferably disposed to be separated from the opening portion 12a by a predetermined distance in an attached state. This is to reduce a possibility that, when the tobacco stick 100 is unintentionally detached by a user at the time of being heated by the microwaves, the microwave shield SD2 is immediately positioned outside the guide portion 13 and the microwaves leak.

As described above, holes are formed in the microwave shield SD1b and the microwave shield SD2 to allow air to pass therethrough. In general, when a diameter of the hole is smaller than a half wavelength of the microwave, the microwave is blocked instead of passing through the hole, so that the diameter of the hole needs to be smaller than the half wavelength of the microwave. In the present embodiment, since the wavelength of the microwave having a frequency of 2.45 GHz is about 120 mm, the diameter of the hole may be smaller than 60 mm.

In general, since the outer diameter of the tobacco stick 100 is designed to be smaller than 60 mm, the diameter of the hole formed in the microwave shield SD2 is also designed to be smaller than 60 mm. Further, the diameter of the hole formed in the microwave shield SD1b is designed to be smaller than 60 mm. However, even if the diameter of the hole is smaller than 60 mm, when the hole has a certain size, a part of the microwaves may leak. Further, when the opening ratio (a ratio of the holes to an area of the microwave shield) is large, a part of the microwaves may also leak. Accordingly, in order to prevent the leakage of the microwaves, it is preferable to reduce the diameter of the hole or the opening ratio, but the difficulty of air passage (ventilation resistance) increases as the reduction. Accordingly, the diameter of the hole and the opening ratio are preferably designed in consideration of the blocking of the microwaves and the ventilation resistance.

The microwave shield SD1 and the microwave shield SD2 configured as described above cooperate with each other to form an applicator AP for confining the microwaves from the high-frequency oscillation unit 20. When the microwave shield SD2 is positioned inside the guide portion 13, the applicator AP is in a blocking state in which propagation of the microwaves from the applicator AP to the outside is restricted, and when the microwave shield SD2 is positioned outside the guide portion 13 (that is, outside the flavor inhaler 10), the applicator AP is in a non-blocking state in which the propagation of the microwaves from the applicator AP to the outside is enabled.

### (Reflected Wave Absorption Structure)

Next, the isolator 23 will be described as a configuration for absorbing the reflected waves.

The microwaves oscillated from the high-frequency oscillation unit 20 are emitted as incident waves from the antenna 21 to the accommodating portion 12 through the waveguide 22. The incident waves are absorbed by the tobacco stick 100 to heat the tobacco stick 100, but a part of the incident waves that are not absorbed by the tobacco stick 100 return from the antenna 21 toward the high-frequency oscillation unit 20 as the reflected waves.

The reflected waves are generated by a difference between an impedance on a high-frequency oscillation unit 20 side and an impedance on a tobacco stick 100 side to be heated. If the reflected waves return to the high-frequency oscillation unit 20, the operation of the high-frequency oscillation unit 20 is unstable, which may lead to a failure of the high-frequency oscillation unit 20. Therefore, the isolator 23 is provided between the accommodating portion 12, in which the tobacco stick 100 is provided, and the high-frequency oscillation unit 20.

The isolator 23 absorbs the reflected waves from the accommodating portion 12 and protects the high-frequency oscillation unit 20 from the reflected waves. The isolator 23 includes a circulator 24 that separates the incident waves from the high-frequency oscillation unit 20 and the reflected waves from the accommodating portion 12, and a dummy load 25 that converts the reflected waves propagated from the circulator 24 into heat.

The circulator 24 is configured by arranging a magnetized ferrite material at a branch portion of a waveguide having three ports (terminals). The three ports are respectively connected to the high-frequency oscillation unit 20, the antenna 21, and the dummy load 25 via the waveguide 22. The incident waves from the high-frequency oscillation unit 20 are propagated from the circulator 24 to the antenna 21. The reflected waves from the accommodating portion 12 are propagated to the circulator 24 and propagated from the circulator 24 to the dummy load 25. That is, the circulator 24 separates paths of the incident waves and the reflected waves.

The dummy load 25 is connected to the circulator 24 via the waveguide 22. The dummy load 25 is a termination resistor that absorbs the reflected waves propagated from the circulator 24 and converts the reflected waves into heat.

In this way, by connecting the isolator 23 between the high-frequency oscillation unit 20 and the accommodating portion 12, the reflected waves can be prevented from being propagated to the high-frequency oscillation unit 20 and the high-frequency oscillation unit 20 can be protected from the reflected waves.

In the present embodiment, the dummy load 25 is disposed to be capable of exchanging heat with the air passing through the air flow path 14. Specifically, the dummy load 25 is provided in the air flow path 14, and can exchange heat obtained from the reflected waves with the air flowing from the air intake port 14a to the accommodating portion 12. Accordingly, the dummy load 25 can be cooled by air cooling, and the air introduced into the accommodating portion 12 can be heated in advance, thereby improving heating efficiency of the tobacco stick 100.

The dummy load 25 may not be provided in the air flow path 14. In this case, the dummy load 25 may be in contact with a member forming the air flow path 14, or may be disposed apart from the member forming the air flow path 14 by a distance at which heat exchange is possible. In addition, when the dummy load 25 is disposed apart from the member forming the air flow path 14, a heat conductive member may be provided between the dummy load 25 and the air flow path 14. Accordingly, the dummy load 25 can also exchange heat with the air passing through the air flow path 14. For example, the heat conductive member may be made of a material such as copper or aluminum having high thermal conductivity, or may be a thermal pad made of silicon. Since the dummy load 25 does not need to be provided in the air flow path 14, a degree of freedom in the configuration and arrangement of the dummy load 25 and the air flow path 14 can be increased.

The microwaves may propagate into the air flow path 14 through a connection portion between the dummy load 25 and the air flow path 14. For example, when the reflected waves are not sufficiently absorbed by the dummy load 25, the reflected waves (that is, the microwaves) may leak to the air flow path 14. In addition, when the dummy load 25 is provided in the air flow path 14, a gap is formed at the connection portion between the dummy load 25 and the air flow path 14, and for example, the microwaves leaking from the high-frequency oscillation unit 20 may leak to the air flow path 14 through the gap. Therefore, in the present embodiment, a microwave shield SD3 that blocks the microwaves propagated through the connection portion between the dummy load 25 and the air flow path 14 is provided in the air flow path 14. The same applies to the case where the above-described heat conductive member is provided in the air flow path 14.

The microwave shield SD3 includes microwave shields SD3a which are provided on an upstream side (an air intake port 14a side) and a downstream side (an accommodating portion 12 side) of the dummy load 25, and each of which blocks the microwaves and allows air to pass therethrough, and a microwave shield SD3b formed on an inner peripheral surface of the air flow path 14 between the microwave shields SD3a on the upstream side and the downstream side. Similar to the microwave shields SD1 and SD2, the microwave shield SD3 is made of a material that does not transmit the microwaves. The microwave shield SD3a is, for example, a metal mesh or a punched metal. The microwave shield SD3b is, for example, a metal layer. Since the microwave shield SD3 is provided, the microwaves can be prevented from leaking to the outside through the connection portion between the dummy load 25 (or the heat conductive member) and the air flow path 14. Here, the microwave shield SD3 corresponds to a “first microwave shield” in the present invention.

When the microwaves are sufficiently absorbed by the dummy load 25, the microwave shield SD3 may not be provided.

### Second Embodiment

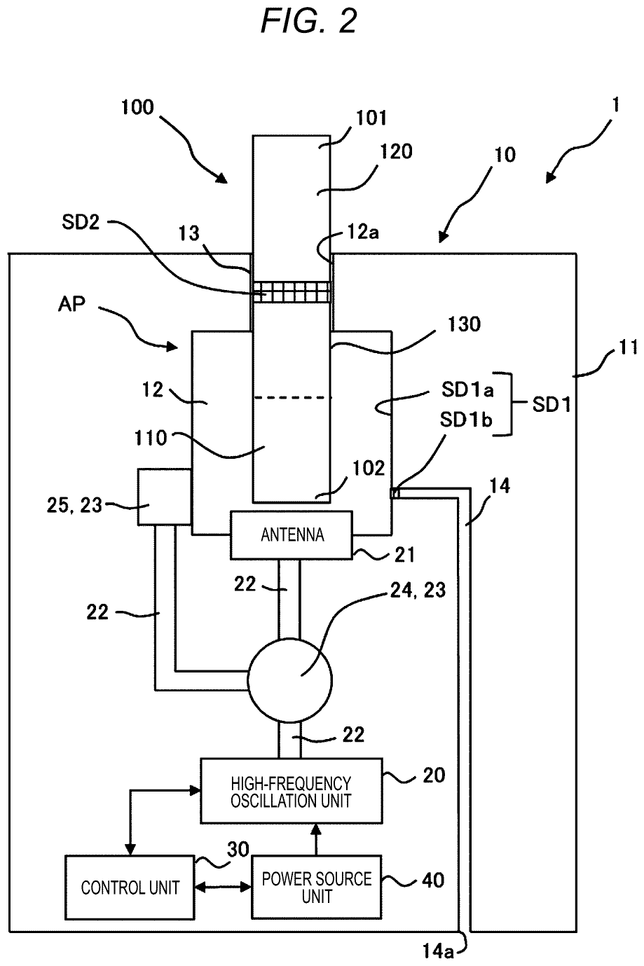

Next, the aerosol generation system 1 that is a second embodiment of the present invention will be described with reference to FIG. 2. The aerosol generation system 1 of the second embodiment is different from that of the first embodiment in a position where the dummy load 25 is disposed. In the aerosol generation system 1 of the second embodiment, the same components as those of the first embodiment are denoted by the same reference numerals, and description thereof is omitted.

In the present embodiment, the dummy load 25 is disposed in the vicinity of the accommodating portion 12 and configured to transfer heat obtained from the reflected waves to the accommodating portion 12. Accordingly, the heat generated by the dummy load 25 can be used to heat the tobacco stick 100, and the heating efficiency of the tobacco stick 100 can be improved.

### <<Configuration of Tobacco Stick>>

Next, a configuration of the tobacco stick 100 according to the above embodiment will be described in detail with reference to FIGS. 3 and 4.

As described above, the tobacco stick 100 includes the tobacco rod portion 110, the mouthpiece portion (inhalation port portion) 120, the tipping paper 130, and the microwave shield SD2. In the example shown in FIGS. 3 and 4, the tobacco stick 100 has a substantially constant diameter over an entire length in a longitudinal direction (hereinafter, also referred to as an axial direction or a Z direction) from the mouthpiece end 101 to the tip end 102. An X direction and a Y direction in FIGS. 3 and 4 are directions orthogonal to the Z direction.

### <Tipping Paper>

A material of the tipping paper 130 is not particularly limited, and it is possible to use a paper made of a general plant fiber (pulp), a sheet using a polymer-based (polypropylene, polyethylene, nylon, or the like) chemical fiber, a polymer-based sheet, a metal foil, or a composite material obtained by combining these. For example, the tipping paper 130 may be made of a composite material obtained by attaching a polymer-based sheet to a paper base. The tipping paper 130 referred to here means a sheet-shaped material that connects a plurality of segments on the tobacco stick 100, such as coupling the tobacco rod portion 110 and the mouthpiece portion 120.

A basis weight of the tipping paper 130 is not particularly limited, but is usually 32 gsm or more and 40 gsm or less, preferably 33 gsm or more and 39 gsm or less, and more preferably 34 gsm or more and 38 gsm or less. A ventilation rate of the tipping paper 130 is not particularly limited, but is usually 0 coresta unit or more and 30000 coresta unit or less, and preferably more than 0 coresta unit and 10000 coresta unit or less. The ventilation rate is a value measured according to ISO 2965:2009, and is represented by a flow rate (cm³) of a gas passing through an area of 1 cm² every minute when a differential pressure between both surfaces of a paper is 1 kPa. One coresta unit (one coresta unit, 1 C.U.) is cm³/(min cm²) under 1 kPa.

The tipping paper 130 may contain a filler in addition to the pulp described above, examples thereof include metal carbonates such as calcium carbonate and magnesium carbonate; metal oxides such as titanium oxide, titanium dioxide, and aluminum oxide; metal sulfates such as barium sulfate, and calcium sulfate; metal sulfides such as zinc sulfide; quartz; kaolin; talc; diatomaceous earth; and gypsum, and in particular, the calcium carbonate is preferably contained from the viewpoint of improving whiteness and opacity and increasing a heating rate. These fillers may be used alone or in combination of two or more.

In addition to the pulp and the filler, various auxiliary agents may be added to the tipping paper 130, for example, a water resistance improver can be added in order to improve water resistance. The water resistance improver contains a wet paper strength enhancer (WS agent) and a sizing agent. Examples of the wet paper strength enhancer include urea formaldehyde resin, melamine formaldehyde resin, and polyamide epichlorohydrin (PAE). Examples of the sizing agent include rosin soap, alkyl ketene dimer (AKD), alkenyl succinic anhydride (ASA), and highly saponified polyvinyl alcohol having a saponification degree of 90% or more.

A coating agent may be added to at least one of two surfaces including a front surface and a back surface of the tipping paper 130. The coating agent is not particularly limited, but a coating agent capable of forming a film on the front surface of the paper to reduce liquid permeability is preferable.

A method of manufacturing the tipping paper 130 is not particularly limited, and a general method can be applied, and in a case of a mode containing the pulp as a main component, for example, there is a method of adjusting texture by using the pulp in a paper making process using a Fourdrinier paper machine, a cylinder paper machine, a cylindrical short composite paper machine, or the like. If necessary, the wet paper strength enhancer may be added to impart water resistance to a wrapping paper, or the sizing agent may be added to adjust a printing condition of the wrapping paper.

### <Tobacco Rod Portion>

A configuration of the tobacco rod portion 110 is not particularly limited, and can have a general configuration. For example, a configuration in which a tobacco filling material 111 is wrapped with a wrapping paper 112 can be used.

### [Tobacco Filling Material]

The tobacco filling material 111 includes, for example, tobacco leaves, extracts of tobacco leaves, and processed products of these as a flavor source. In the present embodiment, the tobacco filling material 111 includes tobacco cuts. A material of the tobacco cuts contained in the tobacco filling material 111 is not particularly limited, and a known material such as a lamina or a backbone can be used. Further, dried tobacco leaves may be pulverized to have an average particle diameter of 20 μm or more and 200 μm or less to obtain a pulverized tobacco product, and the tobacco product may be homogenized and processed into a sheet (hereinafter also simply referred to as uniformed sheet), which is then cut into pieces. Further, a so-called strand type may be obtained in which the uniformed sheet having substantially the same length as that in a longitudinal direction of a tobacco rod is cut substantially horizontally to the longitudinal direction of the tobacco rod to fill the tobacco rod. In addition, a width of the tobacco cut is preferably 0.5 mm or more and 2.0 mm or less in filling the tobacco rod portion 110. A content of the dried tobacco leaves contained in the tobacco rod portion 110 is not particularly limited, but can be 200 mg/rod portion or more and 800 mg/rod portion or less, and is preferably 250 mg/rod portion or more and 600 mg/rod portion or less. This range is particularly suitable for the tobacco rod portion 110 having a circumference of 22 mm and a length of 20 mm.

Various types of tobaccos can be used as the tobacco leaves used in the producing of the tobacco cuts and the uniformed sheet. Examples of the tobacco include yellow varieties, burley varieties, local varieties, other Nicotiana tabacum varieties, Nicotiana rustica varieties, and a mixture thereof. The mixture can be used by appropriately blending the above various types to obtain a desired flavor. Details of the variety of tobacco are disclosed in “Tobacco Encyclopedia, Tobacco Research Center, Mar. 31, 2009”. There are a plurality of related-art methods as a method of manufacturing the uniformed sheet, that is, a method of pulverizing and processing the tobacco leaves into the uniformed sheet. A first method is a method of producing the sheet using a paper making process. A second method is a method in which an appropriate solvent such as water is mixed into pulverized tobacco leaves, the mixture is homogenized, and then the homogenized product is thinly cast on a metal plate or a metal plate belt and dried to produce a cast sheet. A third method is a method of producing a rolled sheet by mixing an appropriate solvent such as water into pulverized tobacco leaves, homogenizing the mixture, and extruding the mixture into a sheet shape. Details of a type of the uniformed sheet are disclosed in “Tobacco Encyclopedia, Tobacco Research Center, Mar. 31, 2009”.

A moisture content of the tobacco filling material 111 is, for example, 10% by weight or more and 15% by weight or less with respect to a total amount of the tobacco filling material 111, and is preferably 11% by weight or more and 13% by weight or less. When the moisture content is in such a range, occurrence of a curling stain is prevented, and winding suitability at the time of manufacturing the tobacco rod portion 110 is improved. A size of the tobacco cut contained in the tobacco filling material 111 and a preparation method are not particularly limited. For example, a dried tobacco leaf may be cut into a tobacco cut having a width of 0.5 mm or more and 2.0 mm or less. In addition, in a case of using the pulverized product of the uniformed sheet, a tobacco cut obtained by pulverizing the dried tobacco leaves to have an average particle diameter of about 20 μm to 200 μm, homogenizing the pulverized product, and cutting the homogenized product into pieces each having a width of 0.5 mm or more and 2.0 mm or less may be used.

The tobacco filling material 111 contains an aerosol base material that generates aerosol smoke. A type of the aerosol base material is not particularly limited, and an extract substance from various natural products and/or a constituent component thereof can be selected according to an application. Examples of the aerosol base material include glycerin, propylene glycol, triacetin, 1,3-butanediol, and a mixture thereof. A content of the aerosol base material in the tobacco filling material 111 is not particularly limited, and is usually 5% by weight or more, preferably 10% by weight or more, further usually 50% by weight or less, and preferably 15% by weight or more and 25% by weight or less, with respect to the total amount of the tobacco filling material from the viewpoint of sufficiently generating the aerosol and imparting a good flavor.

The tobacco filling material 111 may contain a fragrance. A type of the fragrance is not particularly limited, and from the viewpoint of imparting a good flavor, examples of the fragrance include acetanisole, acetophenone, acetylpyrazine, 2-acetylthiazole, alfalfa extract, amyl alcohol, amyl butyrate, trans-anethole, star anise oil, apple juice, balsam Peru oil, beeswax absolute, benzaldehyde, benzoin resinoid, benzyl alcohol, benzyl benzoate, benzyl phenylacetate, benzyl propionate, 2,3-butanedione, 2-butanol, butyl butyrate, butyric acid, caramel, cardamom oil, carob absolute, β-carotene, carrot juice, L-carvone, β-caryophyllene, cassia bark oil, cedarwood oil, celery seed oil, chamomile oil, cinnamaldehyde, cinnamic acid, cinnamyl alcohol, cinnamyl cinnamate, citronella oil, DL-citronellol, clary sage extract, cocoa, coffee, cognac oil, coriander oil, cuminaldehyde, davana oil, δ-decalactone, γ-decalactone, decanoic acid, dillherb oil, 3,4-dimethyl-1,2-cyclopentanedione, 4,5-dimethyl-3-hydroxy-2,5-dihydrofuran-2-one, 3,7-dimethyl-6-octenoic acid, 2,3-dimethylpyrazine, 2,5-dimethylpyrazine, 2,6-dimethylpyrazine, ethyl 2-methylbutyrate, ethyl acetate, ethyl butyrate, ethyl hexanoate, ethyl isovalerate, ethyl lactate, ethyl laurate, ethyl levulinate, ethyl maltol, ethyl octanoate, ethyl oleate, ethyl palmitate, ethyl phenylacetate, ethyl propionate, ethyl stearate, ethyl valerate, ethyl vanillin, ethyl vanillin glucoside, 2-ethyl-3, (5 or 6)-dimethylpyrazine, 5-ethyl-3-hydroxy-4-methyl-2 (5H)-furanone, 2-ethyl-3-methylpyrazine, eucalyptol, fenugreek absolute, gene absolute, gentian root infusion, geraniol, geranyl acetate, grape juice, guaiacol, guava extract, γ-heptalactone, γ-hexalactone, hexanoic acid, cis-3-hexen-1-ol, hexyl acetate, hexyl alcohol, hexyl phenylacetate, honey, 4-hydroxy-3-pentenoic acid lactone, 4-hydroxy-4-(3-hydroxy-1-butenyl)-3,5,5-trimethyl-2-cyclohexen-1-one, 4-(para-hydroxyphenyl)-2-butanone, sodium 4-hydroxyundecanoate, inmoltel absolute, β-ionone, isoamyl acetate, isoamyl butyrate, isoamyl phenylacetate, isobutyl acetate, isobutyl phenylacetate, jasmine absolute, kola nut tincture, labdanum oil, lemon terpeneless oil, licorice extract, linalool, linalyl acetate, lovage root oil, maltol, maple syrup, menthol, menthone, L-menthyl acetate, paramethoxybenzaldehyde, methyl-2-pyrrolyl ketone, methyl anthranilate, methyl phenylacetate, methyl salicylate, 4′-methylacetophenone, methylcyclopentenolone, 3-methylvaleric acid, mimosa absolute, molasses, myristic acid, nerol, nerolidol, γ-nonalactone, nutmeg oil, δ-octalactone, octanal, octanoic acid, orange flower oil, orange oil, orris root oil, palmitic acid, ω-pentadecalactone, peppermint oil, petitgrain Paraguayan oil, phenethyl alcohol, phenethyl phenylacetate, phenylacetic acid, piperonal, plum extract, propenylguaetol, propyl acetate, 3-propylidenephthalide, prune juice, pyruvic acid, raisin extract, rose oil, rum, sage oil, sandalwood oil, spearmint oil, styrax absolute, marigold oil, tea distillate, α-terpineol, terpinyl acetate, 5,6,7,8-tetrahydroquinoxaline, 1,5,5,9-tetramethyl-13-oxacyclo (8.3.0.0 (4.9))tridecane, 2,3,5,6-tetramethylpyrazine, thyme oil, tomato extract, 2-tridecanone, triethyl citrate, 4-(2,6,6-trimethyl-1-cyclohexenyl) 2-buten-4-one, 2,6,6-trimethyl-2-cyclohexene-1,4-dione, 4-(2,6,6-trimethyl-1,3-cyclohexadienyl) 2-buten-4-one, 2,3,5-trimethylpyrazine, γ-undecalactone, γ-valerolactone, vanilla extract, vanillin, veratraldehyde, violet leaf absolute, N-ethyl-p-menthane-3-carboxamide (WS-3), and ethyl-2-(p-menthane-3-carboxamide)acetate (WS-5), and the menthol is particularly preferred. In addition, these fragrances may be used alone or in combination of two or more.

A content of the fragrances in the tobacco filling material 111 is not particularly limited, is usually 10000 ppm or more, preferably 20000 ppm or more, and more preferably 25000 ppm or more, and is usually 70000 ppm or less, preferably 50000 ppm or less, more preferably 40000 ppm or less, and still more preferably 33000 ppm or less, from the viewpoint of imparting a good flavor.

### [Wrapping Paper]

The wrapping paper 112 is a sheet material for wrapping the tobacco filling material 111, a configuration thereof is not particularly limited, and a general wrapping paper can be used. For example, as a base paper used for the wrapping paper 112, cellulose fiber paper can be used, and more specifically, hemp, wood, or a mixture thereof can be used. A basis weight of the base paper in the wrapping paper 112 is usually 20 gsm or more, and preferably 25 gsm or more. Meanwhile, a basis weight is usually 65 gsm or less, preferably 50 gsm or less, and more preferably 45 gsm or less. A thickness of the wrapping paper 112 having the above-described characteristics is not particularly limited, is usually 10 μm or more, preferably 20 μm or more, and more preferably 30 μm or more, and is usually 100 μm or less, preferably 75 μm or less, and more preferably 50 μm or less, from the viewpoint of rigidity, ventilation rate, and ease of adjustment during papermaking.

The wrapping paper 112 of the tobacco rod portion 110 (tobacco filling material 111) may have a square shape or a long square shape. When a paper is used as the wrapping paper 112 for wrapping the tobacco filling material 111 (for producing the tobacco rod portion 110), a length of one side may be about 6 mm to 70 mm, a length of the other side may be about 15 mm to 28 mm, a preferable length of the other side may be about 22 mm to 24 mm, and a more preferable length may be about 23 mm.

In addition to the pulp, the wrapping paper 112 may contain a filler. A content of the filler may be 10% by weight or more and less than 60% by weight with respect to a total weight of the wrapping paper 112, and is preferably 15% by weight or more and 45% by weight or less. In the wrapping paper 112, the content of the filler is preferably 15% by weight or more and 45% by weight or less in a preferable range of the basis weight (25 gsm or more and 45 gsm or less). Further, when the basis weight is 25 gsm or more and 35 gsm or less, the content of the filler is preferably 15% by weight or more and 45% by weight or less, and when the basis weight is more than 35 gsm and 45 gsm or less, the content of the filler is preferably 25% by weight or more and 45% by weight or less. As the filler, calcium carbonate, titanium dioxide, kaolin and the like can be used, but the calcium carbonate is preferably used from the viewpoint of increasing the flavor and whiteness.

Various auxiliary agents other than the base paper and the filler may be added to the wrapping paper 112, and for example, a water resistance improver can be added to improve water resistance. The water resistance improver contains a wet paper strength enhancer (WS agent) and a sizing agent. Examples of the wet paper strength enhancer include urea formaldehyde resin, melamine formaldehyde resin, and polyamide epichlorohydrin (PAE). Examples of the sizing agent include rosin soap, alkyl ketene dimer (AKD), alkenyl succinic anhydride (ASA), and highly saponified polyvinyl alcohol having a saponification degree of 90% or more. A paper strengthening agent may be added as the auxiliary agent, and examples thereof include polyacrylamide, cationic starch, oxidized starch, CMC, polyamide epichlorohydrin resin, and polyvinyl alcohol. In particular, it is known that use of the oxidized starch of an extremely small amount improves the ventilation rate (for example, JP2017-218699A). Further, the wrapping paper 112 may be appropriately coated.

A coating agent may be added to at least one of two surfaces including a front surface and a back surface of the wrapping paper 112. The coating agent is not particularly limited, but a coating agent capable of forming a film on the front surface of the paper to reduce liquid permeability is preferable. Examples of the coating agent include alginic acid and salts thereof (for example, sodium salts); polysaccharides such as pectin; cellulose derivatives such as ethyl cellulose, methyl cellulose, carboxy methyl cellulose, and nitrocellulose; and starch and derivatives thereof (for example, ether derivatives such as carboxymethyl starch, hydroxyalkyl starch, and cationic starch, and ester derivatives such as starch acetate, starch phosphate, and starch octenyl succinate).

A length of the tobacco rod portion 110 in an axial direction may be appropriately changed according to a size of the product, but is, for example, 5 mm or more, preferably 10 mm or more, more preferably 12 mm or more, and still more preferably 18 mm or more, and is usually 70 mm or less, preferably 50 mm or less, more preferably 30 mm or less, and still more preferably 25 mm or less.

### <Mouthpiece Portion>

A configuration of the tobacco stick 100 is not particularly limited, and may have a general form. In a form shown in FIGS. 3 and 4, the mouthpiece portion 120 includes two segments (sections), that is, a cooling segment 121 and a filter segment 122. The cooling segment 121 is disposed to be sandwiched between the tobacco rod portion 110 and the filter segment 122 in a state of being in contact therewith. In another form, a gap may be formed between the tobacco rod portion 110 and the cooling segment 121 and between the tobacco rod portion 110 and the filter segment 122. The mouthpiece portion 120 may be implemented by a single segment.

### [Cooling Segment]

A configuration of the cooling segment 121 is not particularly limited as long as the cooling segment 121 has a function of cooling a tobacco smoke mainstream, and for example, may be obtained by processing thick paper into a cylindrical shape. In this case, an inside of the cylindrical shape is hollow, and steam containing the aerosol base material and the tobacco flavor component is cooled by coming into contact with air in the hollow.

One form of the cooling segment 121 may be a paper tube obtained by processing one sheet of paper or a plurality of sheets of paper stuck together into a cylindrical shape. Further, in order to improve a cooling effect by bringing outside air at a room temperature into contact with the steam at a high temperature, holes for introducing the outside air are preferably provided on an outer periphery of the paper tube. The cooling segment 121 is provided with ventilation holes 103 each of which is an opening for taking in the air from the outside. The number of the ventilation holes 103 in the cooling segment 121 is not particularly limited. In the present embodiment, a plurality of ventilation holes 103 are arranged at regular intervals in a peripheral direction of the cooling segment 121. Further, a group of the ventilation holes 103 arranged in the peripheral direction of the cooling segment 121 may be formed in a plurality of stages along an axial direction of the cooling segment 121. By providing the ventilation holes 103 in the cooling segment 121, the low-temperature air flows into the cooling segment 121 from the outside when the tobacco stick 100 is inhaled, and a temperature of a volatile component or the air flowing from the tobacco rod portion 110 can be lowered. In addition, the steam containing the aerosol base material and the tobacco flavor component is condensed by being cooled by the low-temperature air introduced into the cooling segment 121 through the ventilation holes 103. Accordingly, generation of the aerosol is promoted, and a size of aerosol particles can be controlled. By coating an inner surface of the paper tube with a polymer such as polyvinyl alcohol or a polysaccharide such as pectin, the cooling effect can be improved by utilizing heat absorption of the coating and heat of dissolution associated with a phase change. A ventilation resistance of the cylindrical cooling segment is 0 mmH₂O.

When the cooling segment 121 is filled with a sheet or the like for cooling the volatile component or air flowing into the cooling segment 121 from the tobacco rod portion 110, a total surface area of the cooling segment 121 is not particularly limited, and may be, for example, 300 mm²/mm or more and 1000 mm²/mm or less. The surface area is a surface area per length (mm) of the cooling segment 121 in a ventilation direction. The total surface area of the cooling segment 121 is preferably 400 mm²/mm or more, more preferably 450 mm²/mm or more, and is preferably 600 mm²/mm or less, more preferably 550 mm²/mm or less.

For the cooling segment 121, an internal structure thereof preferably has a large total surface area. Accordingly, in a preferred embodiment, the cooling segment 121 may be formed of a sheet of a thin material that is wrinkled, and then pleated, gathered, and folded to form a channel. When there are many pleats or folds within a given volume of the element, the total surface area of the cooling segment 121 increases. A thickness of the constituent material of the cooling segment 121 is not particularly limited, and may be, for example, 5 μm or more and 500 μm or less, and may be 10 μm or more and 250 μm or less.

It is also desirable to use paper as a material of the cooling sheet member from the viewpoint of reducing an environmental load. It is desirable that the paper as the material of the cooling sheet has a basis weight of 30 g/m² to 100 g/m² and a thickness of 20 μm to 100 μm. From the viewpoint of reducing removal of the flavor source component and the aerosol base material component in the cooling segment, it is desirable that a ventilation rate of the paper as the material of the cooling sheet is low, and the ventilation rate is preferably 10 coresta or less. By coating the paper as the material of the cooling sheet with a polymer such as polyvinyl alcohol or a polysaccharide such as pectin, a cooling effect can be improved by utilizing heat absorption of the coating and heat of dissolution associated with a phase change.

The ventilation holes 103 in the cooling segment 121 are preferably disposed at positions separated from a boundary between the cooling segment 121 and the filter segment 122 by 4 mm or more. Accordingly, not only a cooling capacity of the cooling segment 121 can be improved, but also retention of a component generated by heating in the cooling segment 121 can be prevented, and a delivery amount of the component can be improved. It is preferable that the tipping paper 130 is provided with openings at positions respectively directly above (positions vertically overlapping) the ventilation holes 103 provided in the cooling segment 121. The openings of the cooling segment 121 are preferably provided such that a rate of air inflowing from the openings when inhaling is performed with an automatic smoking machine at 17.5 ml/see (a volume rate of air inflowing from the openings when a rate of air inhaled from the mouthpiece end is 100% by volume) is 10% to 90% by volume, preferably 50% to 80% by volume, and more preferably 55% to 75% by volume, which can be achieved by, for example, selecting the number of openings V per opening group from a range of 5 to 50, selecting a diameter of the opening V from a range of 0.1 mm to 0.5 mm, and combining these selections. The air inflow ratio can be measured by a method according to ISO9512 using an automatic smoking machine (for example, one automatic smoking machine manufactured by Borgwaldt KC). A length of the cooling segment 121 in the axial direction (ventilation direction) is not particularly limited, is usually 10 mm or more and preferably 15 mm or more, and is usually 40 mm or less, preferably 35 mm or less, and more preferably 30 mm or less. The length of the cooling segment 121 in the axial direction is particularly preferably 20 mm. By setting the length of the cooling segment 121 in the axial direction to the lower limit or more, a sufficient cooling effect can be secured and a good flavor can be obtained. In addition, by setting the length of the cooling segment 121 in the axial direction to the upper limit or less, a loss caused by the steam and the aerosol generated during use adhering to an inner wall of the cooling segment 121 can be prevented.

### [Filter Segment]

A configuration of the filter segment 122 is not particularly limited as long as the filter segment 122 has a function as a general filter, and for example, one obtained by processing cellulose acetate tow into a cylindrical shape can be used. Although single yarn fineness and total fineness of the cellulose acetate tow are not particularly limited, and when the filter segment 122 has a circumference of 22 mm, the single yarn fineness is preferably 5 g/9000m to 20 g/9000m and the total fineness is preferably 12000 g/9000m to 30000 g/9000m. A cross-sectional shape of the fiber of the cellulose acetate tow may be a Y cross-section or an R cross-section. When the filter segment 122 is formed by filling the filter segment 122 with the cellulose acetate tow, 5% to 10% by weight of triacetin with respect to a weight of the cellulose acetate tow may be added in order to improve hardness of the filter. In the example shown in FIGS. 3 and 4, the filter segment 122 is implemented by a single segment, but the filter segment 122 may include a plurality of segments. When the filter segment 122 includes a plurality of segments, a form may be exemplified in which a hollow segment such as a center hole is disposed on an upstream side (tobacco rod portion 110 side), and an acetate filter whose inhalation cross section is filled with the cellulose acetate tow is disposed as a segment on a downstream side (mouthpiece end 101 side). According to this form, unnecessary loss of the generated aerosol can be prevented, and an appearance of the tobacco stick 100 can be improved. In addition, from the viewpoint of a change in feeling of inhalation and comfort in the mouth, an acetate filter may be disposed on the upstream side (the tobacco rod portion 110 side), and a hollow segment such as a center hole may be disposed on the downstream side (the mouthpiece end 101 side). In addition, the filter segment 122 may use another alternative filter material such as a paper filter filled with sheet-shaped pulp paper instead of the acetate filter.

Examples of general functions of the filter in the filter segment 122 include adjusting an amount of air mixed when the aerosol or the like is inhaled, reduction of the flavor, reduction of nicotine and tar, and the like, but it is not necessary to have all of these functions. In addition, as compared with a paper tobacco product, falling of the tobacco filling material is prevented while eliminating a filtering function in an electrically heated tobacco product in which an amount of components to be generated is small and a filling rate of the tobacco filling material tends to be low, which is also one of important functions.

A cross-sectional shape of the filter segment 122 is substantially circular, and a diameter of the circle can be appropriately changed according to a size of the product, and is usually 4.0 mm or more and 9.0 mm or less, preferably 4.5 mm or more and 8.5 mm or less, and more preferably 5.0 mm or more and 8.0 mm or less. In a case where the cross section is not circular, when a circle having the same area as an area of the cross section is assumed, a diameter of the circle is applied as the above-described diameter. A circumferential length of the filter segment 122 may be appropriately changed according to the size of the product, and is usually 14.0 mm or more and 27.0 mm or less, preferably 15.0 mm or more and 26.0 mm or less, and more preferably 16.0 mm or more to 25.0 mm or less. The length of the filter segment 122 in the axial direction may be appropriately changed according to the size of the product, and is usually 5 mm or more and 35 mm or less, and preferably 10.0 mm or more and 30.0 mm or less. A shape and dimensions of a filter medium can be appropriately adjusted such that the shape and dimensions of the filter segment 122 fall within the above-described ranges.

The ventilation resistance of the filter segment 122 per 120 mm length in the axial direction is not particularly limited, and is usually 40 mmH₂O or more and 300 mmH₂O or less, preferably 70 mmH₂O or more and 280 mmH₂O or less, and more preferably 90 mmH₂O or more and 260 mmH₂O or less. The ventilation resistance is measured according to the ISO standard method (ISO6565) using, for example, a filter ventilation resistance measuring instrument manufactured by Cerulean Company. The ventilation resistance of the filter segment 122 refers to an air pressure difference between a first end surface and a second end surface when air at a predetermined air flow rate (17.5 cc/min) flows from one end surface (the first end surface) to the other end surface (the second end surface) in a state where the air does not permeate through a side surface of the filter segment 122. A unit of the ventilation resistance can be generally expressed by mmH₂O. It is known that a relationship between the ventilation resistance of the filter segment 122 and the length of the filter segment 122 is a proportional relationship in a length range (length of 5 mm to 200 mm) which is usually used, and when the length of the filter segment 122 is doubled, the ventilation resistance is also doubled.

A density of the filter medium in the filter segment 122 is not particularly limited, and is usually 0.10 g/cm³ or more and 0.25 g/cm³ or less, preferably 0.11 g/cm³ or more and 0.24 g/cm³ or less, and more preferably 0.12 g/cm³ or more and 0.23 g/cm³ or less. The filter segment 122 may include roll paper (filter plug roll paper) which wraps the filter medium or the like from the viewpoint of improving strength and structural rigidity. A form of the roll paper is not particularly limited, and may include one or more rows of adhesive-containing seams. The adhesive may contain a hot melt adhesive, and further the hot melt adhesive may contain polyvinyl alcohol. When the filter segment 122 includes two or more segments, it is preferable that these two or more segments are also wrapped with the roll paper. A material of the roll paper in the filter segment 122 is not particularly limited, a known material can be used, and a filler such as calcium carbonate may be contained.

A thickness of the roll paper is not particularly limited, and is usually 20 μm or more and 140 μm or less, preferably 30 μm or more and 130 μm or less, and more preferably 30 μm or more and 120 μm or less. A basis weight of the roll paper is not particularly limited, and is usually 20 gsm or more and 100 gsm or less, preferably 22 gsm or more and 95 gsm or less, and more preferably 23 gsm or more and 90 gsm or less. The roll paper may or may not be coated, and is preferably coated with a desired material from the viewpoint of being able to impart functions other than strength and structural rigidity.

When the filter segment 122 includes a center hole segment and a filter medium, the center hole segment and the filter medium may be connected by, for example, an outer plug wrapper (outer roll paper). The outer plug wrapper may be, for example, cylindrical paper. In addition, the tobacco rod portion 110, the cooling segment 121, and the connected center hole segment and filter medium may be connected by, for example, mouthpiece lining paper. The connection can be implemented by, for example, applying a glue such as a vinyl acetate-based glue to an inner surface of the mouthpiece lining paper, and inserting and winding the tobacco rod portion 110, the cooling segment 121, and the connected center hole segment and filter medium. These parts may be connected at a plurality of times using a plurality of pieces of lining paper.

The filter medium of the filter segment 122 may include a crushable additive releasing container (for example, a capsule) including a crushable outer shell made of gelatin or the like. A form of the capsule (also referred to as the “additive releasing container” in the technical field) is not particularly limited, a known form may be adopted, and for example, it can be a crushable additive releasing container including a crushable shell made of gelatin or the like. The form of the capsule is not particularly limited, and may be, for example, an easy-to-break capsule, and a shape is preferably a sphere. As an additive of the capsule, any of the above-described additives may be contained, and in particular, a flavoring agent or activated carbon is preferably contained. In addition, as the additive, one or more kinds of materials that assist in filtering smoke may be added. A form of the additive is not particularly limited, and is usually liquid or solid. Further, use of the capsule containing the additives is well known in the technical field. An easy-to-break capsule and a method of producing the same are well known in the present technical field.

The flavoring agent may be, for example, menthol, spearmint, peppermint, fenugreek, cloves, medium-chain fatty acid triglyceride (MCT), or a combination thereof. The flavoring agent of the present embodiment is menthol.

A fragrance may be added to the filter medium of the filter segment 122. By adding the fragrance to the filter medium, a delivery amount of the fragrance at the time of use is increased as compared with a related-art technique in which the fragrance is added to the tobacco filling material constituting the tobacco rod portion 110. A degree of increase in the delivery amount of the fragrance further increases according to positions of the openings provided in the cooling segment 121. A method of adding the fragrance to the filter medium is not particularly limited, and the fragrance may be added to be substantially uniformly dispersed in the filter medium to which the fragrance is to be added. As an addition amount of the fragrance, a form in which the fragrance is added to 10% to 100% by volume of the filter medium can be exemplified. As the addition method, the fragrance may be added to the filter medium in advance before configuring the filter segment, or may be added after configuring the filter segment. The type of the fragrance is not particularly limited, but the same fragrance as those contained in the tobacco filling material 111 described above may be used.

The filter segment 122 includes the filter medium, and activated carbon may be added to at least a part of the filter medium. An addition amount of the activated carbon with respect to the filter medium may be 15.0 m²/cm² or more and 80.0 m²/cm² or less in terms of a value obtained by a specific surface area of the activated carbon×a weight of the activated carbon/a cross-sectional area of the filter medium in a direction perpendicular to the ventilation direction in one tobacco stick 100. The “a specific surface area of the activated carbon× a weight of the activated carbon/a cross-sectional area of the filter medium in a vertical direction with respect to the ventilation direction” may be expressed as a “surface area of the activated carbon per unit cross-sectional area” for convenience. The surface area of the activated carbon per unit cross-sectional area can be calculated based on a specific surface area of the activated carbon added to the filter medium in one tobacco stick 100, a weight of the added activated carbon, and a cross-sectional area of the filter medium. The activated carbon may not be uniformly dispersed in the filter medium to which the activated carbon is added, and does not need to satisfy the above range in all the cross sections (cross sections in a direction perpendicular to the ventilation direction) of the filter medium.

The surface area of the activated carbon per unit cross-sectional area is more preferably 17.0 m²/cm² or more, and still more preferably 35.0 m²/cm² or more. Meanwhile, the surface area of the activated carbon per unit cross-sectional area is more preferably 77.0 m²/cm² or less, and still more preferably 73.0 m²/cm² or less. The surface area of the activated carbon per unit cross-sectional area can be adjusted by, for example, adjusting the specific surface area of the activated carbon, the addition amount of the activated carbon, and the cross-sectional area of the filter medium in the direction perpendicular to the ventilation direction. The surface area of the activated carbon per unit cross-sectional area is calculated based on the filter medium to which the activated carbon is added. When the filter segment 122 includes a plurality of filter mediums, the calculation is based on a cross-sectional area and a length of only the filter medium to which the activated carbon is added.

Examples of the activated carbon include those that are made using wood, bamboo, coconut shell, walnut shell, coal, or the like as a raw material. As the activated carbon, those having a BET specific surface area of 1100 m²/g or more and 1600 m²/g or less, preferably 1200 m²/g or more and 1500 m²/g or less, and more preferably 1250 m²/g or more and 1380 m²/g or less can be used. The BET specific surface area can be determined by a nitrogen gas adsorption method (BET multi-point method). As the activated carbon, those having a pore volume of 400 μL/g or more and 800 μL/g or less, more preferably 500 μL/g or more and 750 μL/g or less, and still more preferably 600 μL/g or more and 700 μL/g or less can be used. The pore volume can be calculated from a maximum adsorption amount obtained using the nitrogen gas adsorption method. The addition amount of the activated carbon per unit length in the ventilation direction of the filter medium to which the activated carbon is added is preferably 5 mg/cm or more and 50 mg/cm or less, more preferably 8 mg/cm or more and 40 mg/cm or less, and still more preferably 10 mg/cm or more and 35 mg/cm or less. By setting the specific surface area of the activated carbon and the addition amount of the activated carbon in the above ranges, the surface area of the activated carbon per unit cross-sectional area can be adjusted to a desired value.

In addition, in the activated carbon, a cumulative 10 vol % particle diameter (particle diameter D10) of the activated carbon particles is preferably 250 μm or more and 1200 μm or less. The cumulative 50 vol % particle diameter (particle diameter D50) of the activated carbon particles is preferably 350 μm or more and 1500 μm or less. The particle diameters D10 and D50 can be measured by a laser diffraction scattering method. As an apparatus suitable for the measurement, a laser-diffraction-scattering-type particle diameter distribution measuring apparatus “LA-950” manufactured by HORIBA, Ltd. can be used. Powder is poured into a cell of the apparatus together with pure water, and the particle diameter is detected based on light scattering information of the particles. Measurement conditions for the measurement apparatus are as follows.
Measurement mode: manual flow motion cell measurement
Dispersion medium: ion-exchanged water
Dispersion method: Measurement after ultrasonic irradiation for one minute
Refractive index: 1.92-0.00i (refractive index of sample)/1.33-0.00i (refractive index of dispersion medium)
The number of times of measurements: measurements of two times with different samples

The method of adding the activated carbon to the filter medium of the filter segment 122 is not particularly limited, and the activated carbon may be added to be substantially uniformly dispersed in the filter medium to which the activated carbon is to be added.

### <Microwave Shield>

The microwave shield SD2 provided on the tobacco stick 100 is attached to the cooling segment 121 on an upstream side of the ventilation holes 103, and is positioned inside the guide portion 13 when the tobacco stick 100 is inserted into the flavor inhaler 10. Accordingly, the microwave shield SD2 can set the applicator AP to the blocking state in cooperation with the guide portion 13.

However, for example, the microwave shield SD2 may be attached to the filter segment 122 or may be disposed adjacent to the filter segment 122 as long as the microwave shield SD2 is positioned inside the guide portion 13 when the tobacco stick 100 is inserted into the flavor inhaler 10. In addition, another filter segment may be provided adjacent to the cooling segment 121, and the microwave shield SD2 may be provided on an end portion on an upstream side or a downstream side of the another filter segment. The microwave shield SD2 may be formed by placing a pre-formed shield member at a predetermined position on the aerosol forming article or by printing on the filter segment 122.

When designing an opening ratio of the microwave shield SD2 in consideration of the blocking of microwaves and the ventilation resistance, the opening ratio is, for example, 10% or more, preferably 30% or more, and more preferably 50% or more. The opening ratio is 90% or less, preferably 80% or less, and more preferably 70% or less. Further, in a case of the above opening ratio of the microwave shield, an overall ventilation resistance of the flavor inhaler 10 and the tobacco stick 100 is 8 mmH₂O or more, preferably 10 mmH₂O or more, and more preferably 12 mmH₂O or more, and is 100 mmH₂O or less, preferably 80 mmH₂O or less, and more preferably 60 mmH₂O or less. In this case, it is possible to provide a system that achieves both prevention of leakage of the microwaves and a desirable ventilation resistance with a simple device configuration. As described above, the ventilation resistance is measured based on the ISO standard method (ISO6565).

The tobacco stick 100 configured as described above may be coated with a lip release material on a part of an outer surface of the tipping paper 130. The lip release material means a material configured to, when a user grips the mouthpiece portion 120 of the tobacco stick 100 with his/her mouth, assist the user in easily separating lips and the tipping paper 130 from each other without substantially adhering to each other. The lip release material may contain, for example, ethyl cellulose, methyl cellulose, or the like. For example, the outer surface of the tipping paper 130 may be coated with the lip release material by applying ethyl cellulose-based ink or methyl cellulose-based ink to the outer surface of the tipping paper 130.

In the present embodiment, the lip release material of the tipping paper 130 is arranged at least in a predetermined mouthpiece region in contact with the lips of the user when the user grips the mouthpiece portion 120. More specifically, on the outer surface of the tipping paper 130, a lip release material arrangement region R1 (see FIG. 3) covered with the lip release material is defined as a region positioned between the mouthpiece end 101 of the mouthpiece portion 120 and the ventilation holes 103.

In addition, a ventilation resistance in a long axis direction per one tobacco stick 100 configured as described above is not particularly limited, is usually 8 mmH₂O or more, preferably 10 mmH₂O or more, and more preferably 12 mmH₂O or more, and is usually 100 mmH₂O or less, preferably 80 mmH₂O or less, and more preferably 60 mmH₂O or less, from the viewpoint of ease of inhalation. The ventilation resistance is measured according to the ISO standard method (ISO6565: 2015) using, for example, a filter ventilation resistance measuring instrument manufactured by Cerulean Company. The ventilation resistance refers to an air pressure difference between a first end surface and a second end surface when air at a predetermined air flow rate (17.5 cc/min) flows from one end surface (the first end surface) to the other end surface (the second end surface) in a state where the air does not permeate through a side surface of the tobacco stick 100. The unit is generally represented by mmH₂O. It is known that a relationship between the ventilation resistance and a length of the tobacco stick 100 is a proportional relationship in a length range (length of 5 mm to 200 mm) which is usually used, and when the length of the tobacco stick 100 is doubled, the ventilation resistance is also doubled.

The rod-shaped tobacco stick 100 preferably has a columnar shape satisfying a shape having an aspect ratio of 1 or more defined as follows.

Aspect ratio=h/w

W is a width of the tip end 102 of the tobacco stick 100, h is a length in the axial direction, and it is preferable that h≥w. A cross-sectional shape of the tobacco stick 100 is not particularly limited, and may be a polygon, a rounded polygon, a circle, an ellipse, or the like. The width w of the tobacco stick 100 is a diameter when the cross-sectional shape of the tobacco stick 100 is a circle, a major axis when the cross-sectional shape is an ellipse, or a diameter of a circumscribed circle or a major axis of a circumscribed ellipse when the cross-sectional shape is a polygon or a rounded polygon. The length h of the tobacco stick 100 in the axial direction is not particularly limited, and is usually 40 mm or more, preferably 45 mm or more, and more preferably 50 mm or more, for example. The length h is usually 100 mm or less, preferably 90 mm or less, and more preferably 80 mm or less. The width w of the tip end 102 of the tobacco stick 100 is not particularly limited, and is usually 5 mm or more, and preferably 5.5 mm or more, for example. Further, the width w is usually 10 mm or less, preferably 9 mm or less, and more preferably 8 mm or less. A ratio of the lengths of the cooling segment 121 and the filter segment 122 (cooling segment: filter segment) in the length of the tobacco stick 100 is not particularly limited, and is usually 0.60 to 1.40:0.60 to 1.40, preferably 0.80 to 1.20:0.80 to 1.20, more preferably 0.85 to 1.15:0.85 to 1.15, still more preferably 0.90 to 1.10:0.90 to 1.10, and particularly preferably 0.95 to 1.05:0.95 to 1.05, from the viewpoint of the delivery amount of the fragrance and an appropriate aerosol temperature. By setting the ratio of the lengths of the cooling segment 121 and the filter segment 122 within the above range, a cooling effect, an effect of preventing the loss caused by adhesion of the generated steam and aerosol to the inner wall of the cooling segment 121, and balancing in adjustment function of the air amount and the flavor of the filter, and good flavor and strength of the flavor can be realized.

The above embodiments can be freely combined. The above embodiments are examples and are not intended to limit the scope of the invention. The above-described embodiments can be implemented in various other forms, and various omissions, replacements, and modifications can be made without departing from the gist of the invention. The accompanying embodiments and their equivalents are intended to cover such forms or modifications as would fall within the scope and spirit of the inventions.

In the above embodiments, the tobacco stick 100 is shown as an example of the “aerosol forming article” in the present invention, but the present invention is not limited thereto. For example, the “aerosol forming article” may be a filler containing an aerosol source and including a microwave shield. The aerosol source includes the aerosol base material described above. The aerosol source may contain a flavor source, and the flavor source may be a plant other than tobacco, for example, mint, Chinese medicine, and herb. Further, the “aerosol forming article” does not need to have a stick shape, and may have a capsule shape or a cartridge shape.

The first embodiment and the second embodiment may be combined, and the dummy load 25 may be provided in the air flow path 14 and in the vicinity of the accommodating portion 12.

A power monitor that detects power of the incident waves and the reflected waves may be provided between the antenna 21 and the circulator 24. Accordingly, information related to the power of the incident waves and the reflected waves in the waveguide 22 can be obtained.

An impedance matching unit may be provided between the antenna 21 and the circulator 24 to reduce the power of the reflected waves by matching the impedance on the high-frequency oscillation unit 20 side and the impedance on the tobacco stick 100 side. The impedance matching unit is, for example, a three-stub tuner or an E-H tuner.

In the present specification, at least the following matters are described. In parentheses, corresponding constituent components and the like in the above-mentioned embodiment are indicated, but the present invention is not limited thereto.
(1) An aerosol generation device (flavor inhaler 10) including:
an accommodating portion (accommodating portion 12) provided in a case (case 11) and configured to accommodate at least a part of an aerosol source (tobacco rod portion 110);
a microwave oscillation unit (high-frequency oscillation unit 20) configured to oscillate microwaves;
a power source unit (power source unit 40) configured to supply electric power to the microwave oscillation unit;
an antenna (antenna 21) configured to supply the microwaves to the accommodating portion;
an isolator (isolator 23) connected between the microwave oscillation unit and the accommodating portion; and
an air flow path (air flow path 14) configured to allow air to be taken into the accommodating portion from an outside of the case, in which
the isolator includes a circulator (circulator 24) that separates incident waves oscillated from the microwave oscillation unit and reflected waves reflected from the accommodating portion.

According to (1), since the isolator is connected between the microwave oscillation unit and the accommodating portion, the reflected waves can be prevented from being propagated to the high-frequency oscillation unit and the high-frequency oscillation unit can be protected from the reflected waves.

(2) The aerosol generation device according to (1), in which

the isolator further includes a dummy load (dummy load 25) that converts the reflected waves into heat.

According to (2), since the dummy load converts the reflected waves into heat, the converted heat can be effectively utilized.

(3) The aerosol generation device according to (2), in which

the dummy load is disposed to be able to exchange heat with air passing through the air flow path.

According to (3), since the dummy load is disposed to be able to exchange heat with the air passing through the air flow path, the dummy load can be cooled by air cooling, and the air introduced into the accommodating portion can be heated in advance. Accordingly, heating efficiency of an aerosol forming article can be improved.

(4) The aerosol generation device according to (3), in which

the dummy load is provided in the air flow path.

According to (4), since the dummy load is disposed in the air flow path, the dummy load can be cooled by air cooling, and the air introduced into the accommodating portion can be heated in advance. Accordingly, the heating efficiency of the aerosol forming article can be improved.

(5) The aerosol generation device according to (4), in which

a first microwave shield (microwave shield SD3) is provided in the air flow path, the first microwave shield being configured to block the microwaves propagated from a connection portion between the dummy load and the air flow path.

According to (5), since the first microwave shield that blocks the microwaves propagated from the connection portion between the dummy load and the air flow path is provided in the air flow path, leakage of the microwaves from the air flow path to the outside can be prevented.

(6) The aerosol generation device according to (3), in which the dummy load is disposed to be able to exchange heat, via a heat conductive member, with air passing through the air flow path.

According to (6), since the dummy load is disposed to be able to exchange heat, via the heat conductive member, with the air passing through the air flow path, the dummy load can be cooled by air cooling, and the air introduced into the accommodating portion can be heated in advance. Accordingly, the heating efficiency of the aerosol forming article can be improved. In addition, a degree of freedom in configuration and arrangement of the dummy load and the air flow path can be increased.

(7) The aerosol generation device according to (6), in which

a first microwave shield (microwave shield SD3) is provided in the air flow path, the first microwave shield being configured to block the microwaves propagated through a connection portion between the heat conductive member and the air flow path.

According to (7), since the first microwave shield that blocks the microwaves propagated through the connection portion between the heat conductive member and the air flow path is provided in the air flow path, leakage of the microwaves from the air flow path to the outside can be prevented.

(8) The aerosol generation device according to (2), in which

the dummy load is disposed in a vicinity of the accommodating portion.

According to (8), since the dummy load is disposed in the vicinity of the accommodating portion, heat generated by the dummy load can be used to heat the aerosol forming article. Accordingly, the heating efficiency of the aerosol forming article can be improved.

(9) The aerosol generation device according to any one of (1) to (8), in which a second microwave shield (microwave shield SD1b) is provided in the air flow path, the second microwave shield being configured to block the microwaves from the accommodating portion and allows air to pass therethrough.

According to (9), since the second microwave shield is provided in the air flow path, the microwaves from the accommodating portion can be prevented from leaking to the outside from the air flow path.

(10) The aerosol generation device according to any one of (1) to (9), in which the aerosol source includes a flavor source for flavoring aerosol.

According to (10), flavored aerosol can be generated.

(11) An aerosol generation system (aerosol generation system 1) including:
an aerosol forming article (tobacco stick 100) containing an aerosol source;
an accommodating portion (accommodating portion 12) provided in a case (case 11) and configured to accommodate at least a part of the aerosol source;
a microwave oscillation unit (high-frequency oscillation unit 20) configured to oscillate microwaves;
a power source unit (power source unit 40) configured to supply electric power to the microwave oscillation unit;
an antenna (antenna 21) configured to supply the microwaves to the accommodating portion;
an isolator (isolator 23) connected between the microwave oscillation unit and the accommodating portion; and
an air flow path (air flow path 14) configured to allow air to be taken into the accommodating portion from an outside of the case, in which the isolator includes a circulator (circulator 24) that separates incident waves oscillated from the microwave oscillation unit and reflected waves reflected from the accommodating portion.

According to (11), since the isolator is connected between the microwave oscillation unit and the accommodating portion, the reflected waves can be prevented from being propagated to the high-frequency oscillation unit and the high-frequency oscillation unit can be protected from the reflected waves.

What is claimed is:

1. An aerosol generation device comprising:
an accommodating portion provided in a case and configured to accommodate at least a part of an aerosol source;
a microwave oscillation unit configured to oscillate microwaves;
a power source unit configured to supply electric power to the microwave oscillation unit;
an antenna configured to supply the microwaves to the accommodating portion;
an isolator connected between the microwave oscillation unit and the accommodating portion; and
an air flow path configured to allow air to be taken into the accommodating portion from an outside of the case, wherein
the isolator includes a circulator that separates incident waves oscillated from the microwave oscillation unit and reflected waves reflected from the accommodating portion.

2. The aerosol generation device according to claim 1, wherein
the isolator further includes a dummy load that converts the reflected waves into heat.

3. The aerosol generation device according to claim 2, wherein
the dummy load is disposed to be able to exchange heat with air passing through the air flow path.

4. The aerosol generation device according to claim 3, wherein
the dummy load is provided in the air flow path.

5. The aerosol generation device according to claim 4, wherein
a first microwave shield is provided in the air flow path, the first microwave shield being configured to block the microwaves propagated through a connection portion between the dummy load and the air flow path.

6. The aerosol generation device according to claim 3, wherein
the dummy load is disposed to be able to exchange heat, via a heat conductive member, with air passing through the air flow path.

7. The aerosol generation device according to claim 6, wherein
a first microwave shield is provided in the air flow path, the first microwave shield being configured to block the microwaves propagated through a connection portion between the heat conductive member and the air flow path.

8. The aerosol generation device according to claim 2, wherein
the dummy load is disposed in a vicinity of the accommodating portion.

9. The aerosol generation device according to claim 1, wherein
a second microwave shield is provided in the air flow path, the second microwave shield being configured to block the microwaves from the accommodating portion and to allow air to pass therethrough.

10. The aerosol generation device according to claim 1, wherein
the aerosol source includes a flavor source for flavoring aerosol.

11. An aerosol generation system comprising:
an aerosol forming article containing an aerosol source;
an accommodating portion provided in a case and configured to accommodate at least a part of the aerosol source;
a microwave oscillation unit configured to oscillate microwaves;
a power source unit configured to supply electric power to the microwave oscillation unit;
an antenna configured to supply the microwaves to the accommodating portion;
an isolator connected between the microwave oscillation unit and the accommodating portion; and
an air flow path configured to allow air to be taken into the accommodating portion from an outside of the case, wherein
the isolator includes a circulator that separates incident waves oscillated from the microwave oscillation unit and reflected waves reflected from the accommodating portion.
